(19) United States
(12) Patent Application Publication
(10) Pub. No.: US 2004/0209166 A1
(43) Pub. Date: Oct. 21, 2004

(54) Nickel hydrogen secondary battery

(76) Inventor: Masaru Kihara, Takasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/720,700

(22) Filed: Nov. 25, 2003

(30) Foreign Application Priority Data
Nov. 28, 2002 (JP) 2002-345997

(51) Int. Cl. H01M 4/58; H01M 4/32

(52) U.S. Cl. 429/218.2; 429/223

(57) ABSTRACT

A nickel-hydrogen secondary battery comprises a positive electrode (10) and a negative electrode (12) opposite each other with a separator (18) between, and contained in a container (14) with an alkaline electrolyte. The positive electrode (10) contains nickel hydroxide and

at least one element selected from a group consisting of Y, Yb, Er, Ca, Sr, Ba, Nb, Ti, W, Mo and Ta. The negative electrode (12) contains a hydrogen-absorbing alloy having composition represented by a general formula Ln₁-ₓMgₓ(Ni_{1-y}T_{y})ₛ, where Ln is at least one element selected from a group consisting of the lanthanoids, Ca, Sr, Sc, Y, Ti, Zr and Hf, T is at least one element selected from a group consisting of V, Nb, Ta, Cr, Mo, Mn, Fe, Co, Al, Ga, Zn, Sn, In, Cu, Si, P and B, and x, y and z are numerical values satisfying the requirements 0<x<1, O≦y≦0.5, and 2.5≦z≦4.5, respectively.

This nonprovisional application claims priority under 35 U.S.C. § 119(a) on Patent Application No. 2002-345997 filed in Japan on Nov. 28, 2002, the entire contents of which are hereby incorporated by reference.

### BACKGROUND OF THE INVENTION

1. Field of the Invention

The present invention relates to a nickel-hydrogen secondary battery.

2. Description of the Related Art

The nickel-hydrogen secondary battery has a positive electrode using nickel hydroxide as an active material. Such a positive electrode has high energy density when the battery is charged in a room temperature atmosphere of, for example, 20° C., whereas the electrode has lower energy density when the battery is charged in a high-temperature atmosphere due to the reduction of the oxygen generating potential of the positive electrode. Specifically, when the battery is charged in a high-temperature atmosphere, the reaction in which oxygen is generated occurs at the same time as the reaction in which nickel hydroxide is converted into nickel oxyhydroxide. Hence, nickel hydroxide is not charged enough during charging, so that the active material utilization efficiency becomes lower.

As a positive electrode in which the charging efficiency in a high-temperature atmosphere is raised by restraining the above-mentioned oxygen generating reaction, there has been proposed a positive electrode which contains a predetermined additive in addition to nickel hydroxide. For example, Japanese Unexamined Patent Publication No. hei10-294109 discloses a positive electrode in which metallic yttrium powder or yttrium compound powder is added, and Japanese Unexamined Patent Publication No. hei10-294109 discloses a positive electrode in which Ca or the like is added.

### SUMMARY OF THE INVENTION

A nickel-hydrogen secondary battery comprises a positive electrode and a negative electrode opposite each other with a separator between, and contained in a container with an alkaline electrolyte. The positive electrode contains nickel hydroxide and at least one element selected from a group consisting of Y, Yb, Er, Ca, Sr, Ba, Nb, Ti, W, Mo and Ta. The negative electrode contains a hydrogen-absorbing alloy having composition represented by a general formula Ln₁₋ₓMgₓ(Ni_{1-y}T_{y})_{z}, where Ln is at least one element selected from a group consisting of the lanthanoids, Ca, Sr, Sc, Y, Ti, Zr and Hf, T is at least one element selected from a group consisting of V, Nb, Ta, Cr, Mo, Mn, Fe, Co, Al, Ga, Zn, Sn, In, Cu, Si, P and B, and x, y and z are numerical values satisfying the requirements 0<x<1, 0≦y≦0.5, and 2.5≦z≦4.5, respectively.

A further scope of applicability of the present invention will become apparent from the detailed description given hereinafter. However, it should be understood that the detailed description and specific example, while indicating a preferred embodiment of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawing which is given by way of illustration only, and thus, is not limitative of the present invention, and wherein:

FIG. 1 is a perspective view showing a nickel-hydrogen secondary battery according to an embodiment of the invention, in which a part thereof is cut away.

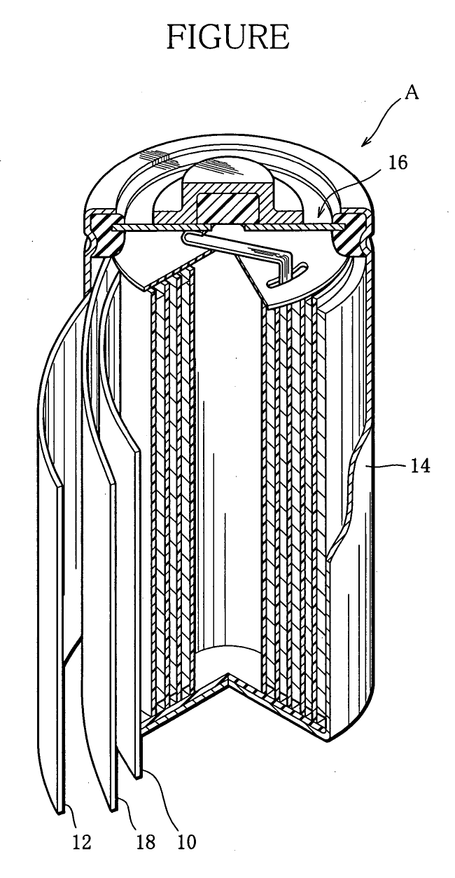

### DETAILED DESCRIPTION

A nickel-hydrogen secondary battery using any of the positive electrodes disclosed in the above-mentioned unexamined patent publications has a problem that the continuous charging characteristic, namely the characteristic that the battery shows when charged continuously or continually for a long time is not at a satisfactory level. This problem comes from the following:

The additive including metallic yttrium or the like makes the oxygen generating potential of the positive electrode higher. Hence, when the battery is charged, charging reaction of nickel hydroxide goes on at high charging efficiency. Due to this high charging efficiency, when the battery is charged continuously or continually for a long time, the charging range of the positive electrode extends over a beta nickel oxyhydroxide generating range up to a gamma nickel oxyhydroxide generating range, so that gamma nickel oxyhydroxide is generated.

The density of gamma nickel oxyhydroxide is lower than that of beta nickel oxyhydroxide. Hence, when gamma nickel oxyhydroxide is generated at the positive electrode, the positive electrode or the positive electrode active material swells, so that the alkaline electrolyte is absorbed and held in the positive electrode. Consequently, the amount of the alkaline electrolyte which contributes to electrode reaction in the battery decreases relatively. Thus, the battery becomes harder to be charged and discharged. In other words, when continuous charging is performed, the capacity of the battery decreases.

In order to solve the problem that the battery capacity decreases when continuous charging is performed at high temperature, the inventor made investigations and found that the above problem with high-temperature continuous charging could be alleviated by using, as a hydrogen-absorbing alloy for the negative electrode, an alloy containing Mg, for example, an Re—Mg—Ni alloy (where Re represents a rare-earth element). Thus, the inventor conceived a nickel-hydrogen secondary battery according to the invention.

Embodiments of the invention will now be described with reference to the accompanying Figure. The terminology used in the description presented herein is not intended to be interpreted in any limited or restrictive manner, simply because it is being utilized in conjunction with a detailed description of the specific embodiments of the invention. Furthermore, the embodiments of the invention may include several novel features, no single one of which is solely responsible for its desirable attributes or which is essential to practicing the inventions herein described.

A nickel-hydrogen secondary battery according to an embodiment of the invention (hereinafter referred to as “battery A”) will be described in detail.

Except for a positive electrode 10 and a negative electrode 12 which will be described later, the battery A has the same structure as an conventional battery. For example, the battery A includes a battery container 14 in the shape of a cylinder which has a bottom end and an opening end at the top. The battery container 14 functions as a negative terminal. The opening end of the battery container 14 is closed with a lid member 16 which functions as a positive terminal. The positive electrode 10 and negative electrode 12 are strip-shaped, rolled up with a separator 18 therebetween, and placed in the battery container 14. Thus, in the battery container 14, the positive electrode 10 and negative electrode 12 face each other with the separator between. The positive electrode 10 and the lid member 16 (positive terminal) are electrically connected, while the negative electrode 12 and the battery container 14 (negative terminal) are electrically connected. With these positive electrode 10 and negative electrode 12, an alkaline electrolyte is contained in the battery container 14.

For the separator 18, for example, nonwoven fabric of polyamide fiber or nonwoven fabric of polyolefin fiber such as polyethylene or polypropylene, to which a hydrophilic functional group is added, can be used. As the alkaline electrolyte, for example, an aqueous sodium hydroxide solution, an aqueous lithium hydroxide solution, an aqueous potassium hydroxide solution, or a mixture of two or more of these solutions can be used.

1. Positive Electrode

The positive electrode includes a positive-electrode substrate, which supports a positive-electrode mixture. The positive-electrode substrate may be an ordinary one. For example, foamed nickel having porous structure can be used for the positive-electrode substrate.

In the battery A, the positive-electrode mixture comprises a positive-electrode active material, an additive and a binder. The binder may be an ordinary one. A hydrophilic polymer, a hydrophobic polymer or the like can be used as the binder. Carboxymethylcellulose (CMC) is an example of the hydrophilic polymer, and polytetrafluoroethylene (PTFE) is an example of the hydrophobic polymer.

Also the positive-electrode active material may be an ordinary one. For example, in addition to nickel hydroxide particles, nickel hydroxide particles in which the average valency of nickel is higher than 2.0 (hereinafter referred to also as “higher-order nickel hydroxide particles”) can be used. The nickel hydroxide particle or the higher-order nickel hydroxide particle may contain cobalt, zinc, cadmium or the like in the form of a solid solution. Further, the nickel hydroxide particle or the higher-order nickel hydroxide particle may be a particle whose surface is covered with a coating layer comprising a cobalt compound (hereinafter referred to also as “composite particle”). Further, the composite particle may be a particle in which the cobalt compound contains alkali cations of Na or the like.

The cobalt compound which forms the coating layer of the composite particle may be, for example, dicobalt trioxide (CO₂O₃), cobalt metal (Co), cobalt monoxide (CoO), or cobalt hydroxide (Co(OH)₂).

Among the above-mentioned positive-electrode active materials, the composite particles are supported by the substrate with their surfaces touching each other and thereby form a good conductive network in the positive electrode. This improves the rate of utilization of the positive-electrode active material, and thereby increases the battery capacity. Hence, use of the composite particles is preferable.

The cobalt compound for the composite particle is desirably a higher-order cobalt compound in which the average valency of cobalt is higher than 2.0, and more desirably a higher-order cobalt compound which contains alkali cations of Na, K, Li or the like. The reason is as follows:

When the surface of a higher-order nickel hydroxide particle is coated with a higher-order cobalt compound containing alkali cations, the boundary between the higher-order cobalt compound of the coating layer and the inner higher-order nickel hydroxide disappears, and the bond between the higher-order cobalt compound and higher-order nickel hydroxide becomes stronger. Thus, the mechanical strength of the whole particle including the coating layer increases, the electric resistance between them decreases, and the capacity in high-rate discharging increases.

Moreover, the alkaline cations restrain oxidation of the cobalt compound, and thereby maintain the stability of the cobalt compound and restrain self-discharge of the battery when the battery is left alone.

In the battery A, the additive contained in the positive-electrode mixture is particles of a compound containing at least one element selected from a group consisting of Y, Yb, Er, Ca, Sr, Ba, Nb, Ti, W, Mo and Ta.

The compound may be, for example, Y₂O₃, Nb₂O₅, Yb₂O₃, Er₂O₃, Ca(OH)₂, SrO, Ba(OH)₂, TiO₂, WO₂, WO₃, MoO₂, MoO₃, or Ta₂O₅.

The above-mentioned elements makes the oxygen overvoltage at the positive electrode larger and thereby improves the charging characteristic of the battery A, particularly the charging characteristic that the battery A shows when charged in a high-temperature atmosphere for a short time.

The higher-order nickel hydroxide particles and the higher-order nickel hydroxide particles whose surfaces are coated with a cobalt compound are produced as follows:

In order to produce the higher-order nickel hydroxide particles, while an alkaline aqueous solution with nickel hydroxide particles obtained in a common way in is being stirred, a predetermined amount of an oxidizing agent, for example, sodium hypochlorite is dropped into it. As a result, nickel hydroxide, which is the main constituent of the nickel hydroxide particles, is converted into higher-order nickel hydroxide by oxidation. In this process, the average valency of nickel in the higher-order nickel hydroxide can be controlled by the amount of sodium hypochlorite added to the solution. It is desirable that the average valency of nickel in the higher-order nickel hydroxide is higher than 2 in order to decrease the amount of irreversible hydrogen, namely hydrogen which remains absorbed in the negative electrode and is not released therefrom. The average valency of nickel is more desirably in the range of 2.05 to 2.30, and further more desirably in the range of 2.10 to 2.30.

In order to produce the higher-order nickel hydroxide particles whose surfaces are coated with a cobalt compound, the surfaces of nickel hydroxide particles are coated with a cobalt compound in advance. Then, these particles are heated under coexistence of an alkaline aqueous solution and an oxidizing agent. As a result, nickel hydroxide contained in the particles is converted into to higher-order nickel hydroxide.

The processes for producing the higher-order nickel hydroxide particles whose surfaces are coated with a higher-order cobalt compound containing alkali cations is as follows:

Like the above-described case, the surfaces of nickel hydroxide particles are coated with a cobalt compound in advance. Then, sodium hydroxide is sprayed over the obtained composite particles at a predetermined rate for a predetermined time. As a result, nickel hydroxide particles which has the coating layer comprising a cobalt compound containing alkali cations are obtained. Then, like the above-described case, the nickel hydroxide particles having the coating layer are heated under coexistence of an alkaline aqueous solution and an oxidizing agent. As a result, the cobalt compound which forms the coating layer and the nickel hydroxide under the coating layer are converted into a higher-order cobalt compound and higher-order nickel hydroxide, respectively, at the same time.

In this method, the crystal structure of cobalt hydroxide which coats the surfaces of the nickel hydroxide particles is distorted, and oxidation of cobalt hydroxide is forcibly promoted. As a result, the average valency of cobalt becomes higher than 2, namely a high-order cobalt compound in which the average valency of cobalt is, for example, 2.7 to 3.3 is produced. Consequently, the electroconductivity of the conductive network in the positive electrode is further improved, and the battery capacity is increased.

Here, distorted crystal structure of a cobalt compound means crystal structure including a lot of lattice defects such as point defects, line defects or plane defects. For example, when interstitial or substitutional impurities are taken in crystal lattice, point defects are produced, which distort the crystal lattice.

Whether the crystal structure of a cobalt compound is distorted or not can be determined, for example, by an X-ray diffraction method.

2. Negative Electrode

The negative electrode includes a negative-electrode substrate, which supports a negative-electrode mixture. The negative-electrode substrate may be an ordinary one. For example, punching metal may be used for the negative-electrode substrate.

In the battery A, the negative-electrode mixture comprises a hydrogen-absorbing alloy which can release and absorb hydrogen as a negative-electrode active material, and a binder. The binder may be an ordinary one, as in the positive electrode.

In the battery A, the hydrogen-absorbing alloy in the negative-electrode mixture contains Mg. The function of the hydrogen-absorbing alloy containing Mg can be explained as follows:

In the charge-discharge cycle of the nickel-hydrogen secondary battery, an extremely small amount of the Mg contained in, for example, Re—Mg—Ni alloy dissolves in the alkaline electrolyte as Mg²⁺ ions. The Mg²⁺ ions which have dissolved in the alkaline electrolyte move in the alkaline electrolyte, reach the positive electrode and are taken in the positive electrode.

Although the detailed mechanism is unknown, the Mg taken in the positive electrode restrains production of gamma nickel oxyhydroxide in continuous charging, and even if gamma nickel oxyhydroxide is produced, it restrains the alkaline electrolyte being absorbed into the positive electrode.

Even when the hydrogen-absorbing alloy containing Mg is not used, if an alkaline electrolyte containing Mg²⁺ ions is used, Mg can be likewise taken in the positive electrode to a certain degree. However, the solubility of Mg ions in the alkaline electrolyte is limited. Hence, if Mg is added to the alkaline electrolyte to the amount required to keep the decrease in capacity in high-temperature continuous charging at an allowable level, Mg not dissolved in the alkaline electrolyte is precipitated at undesirable places in the battery. If the amount of added Mg is kept under the solubility limit, Mg²⁺ ions in the alkaline electrolyte are exhausted before continuous charging ends. Hence, in the middle of continuous charging, gamma nickel oxyhydroxide begins to be produced, and the positive electrode begins to swell. Thus, absorption of the alkaline electrolyte into the positive electrode cannot be restrained enough.

In contrast, when the hydrogen-absorbing alloy contains Mg, even when Mg²⁺ ions in the alkaline electrolyte moves into the positive electrode, other Mg²⁺ ions dissolve from the hydrogen-absorbing alloy into the alkaline electrolyte. Thus, Mg²⁺ ions required and sufficient for restraining production of gamma nickel oxyhydroxide can continue to be supplied to the positive electrode. Further, since the amount of Mg²⁺ ions which dissolve from the hydrogen-absorbing alloy into the alkaline electrolyte is extremely small, Mg are not precipitated at undesirable places in the battery.

Incidentally, it might be supposed that Mg could be added to the positive electrode in advance. In this case, Mg dissolves once into the alkaline electrolyte and eventually precipitates at desirable places on the positive electrode. Thus, the same result is expected as that produced when Mg²⁺ ions are added to the alkaline electrolyte.

In order to produce the above-described effect in the battery A, it is desirable to use, as an Re—Mg—Ni alloy containing Mg, a hydrogen-absorbing alloy represented by a general formula:

Ln₁₋ₓMgₓ(Ni_{1-y}T_{y})_{z} (1),

where Ln is at least one element selected from a group consisting of the lanthanoids, Ca, Sr, Sc, Y, Ti, Zr and Hf, T is at least one element selected from a group consisting of V, Nb, Ta, Cr, Mo, Mn, Fe, Co, Al, Ga, Zn, Sn, In, Cu, Si, P and B, and x, y and z are numerical values satisfying the requirements 0<x<1, 0≦y≦0.5, and 2.5≦z≦4.5, respectively.

The grounds for the above limitations on x, y and z in the general formula (1) are as follows:

Regarding x, if x is 0 or not smaller than 1, an inherent property of the Re—Mg—Ni alloy that it absorbs a large amount of hydrogen at room temperature is lost.

Regarding y, if y is larger than 0.5, the amount of hydrogen absorbed by the hydrogen-absorbing alloy decreases.

Regarding z, if z is smaller than 2.5, the hydrogen-absorbing alloy has too high an ability to hold hydrogen and does not easily release hydrogen. If z is larger than 4.5, hydrogen absorbing sites of the hydrogen-absorbing alloy decrease, so that the amount of absorbed hydrogen decreases.

In order to prolong the life of the nickel-hydrogen secondary battery more, it is desirable to decrease the proportion of La in the elements represented by Ln in the general formula (1), to a certain degree. Specifically, the desirable amount of La in the elements represented by Ln is 50 mass-% or lower.

The invention is not limited to the above-described embodiment. Various modifications can be made to it. For example, while the battery A according to the described embodiment is a cylindrical nickel-hydrogen secondary battery, it may be a square nickel-hydrogen secondary battery.

### EXAMPLES

### Example 1

1. Preparation of a Positive Electrode

A mixed aqueous solution of nickel sulfate, zinc sulfate and cobalt sulfate in which the amounts of Zn and Co relative to Ni were 3 mass-% and 1 mass-%, respectively, was prepared. While the mixed solution was being stirred, an aqueous sodium hydroxide solution was gradually added to the mixed aqueous solution for reaction. During the reaction, the pH of the mixed solution was kept at 13 to 14. As a result, suborbicular nickel hydroxide particles were precipitated in the mixed solution. These nickel hydroxide particles were washed three times with ten times as much pure water, then dehydrated and dried. Thus, nickel hydroxide particle powder was obtained.

The nickel hydroxide particle powder thus obtained, diyttrium trioxide (Y₂O₃) powder of the amount corresponding to 5 mass-%, and an HPC (hydroxypropylcellulose) dispersion liquid (dispersion medium consisting of 40 parts of water and 60 parts of solids, by mass) of the amount corresponding to 40 mass-% were mixed so that the nickel hydroxide particle powder and the Y₂O₃ powder would be dispersed uniformly. Thus, positive-electrode active material slurry was obtained. This active material slurry was filled into a foamed nickel substrate and dried. Then, the foamed nickel substrate was pressed and cut. Thus, a non-sintered positive electrode for a nickel-hydrogen secondary battery of AA size was produced.

2. Preparation of a Negative Electrode

Using an induction melting furnace, an ingot of a hydrogen-absorbing alloy containing Mm (misch metal), Mg, Ni, Co and Al in the mole ratio of 0.7:0.3:3.1:0.1:0.2 was prepared, where the misch metal contained 75% La, 15% Nd and 10% Pr by mass as main constituents. Specifically, the metal of the above composition was heat-treated in an argon atmosphere at 1000° C. for 10 hours to obtain an ingot of a hydrogen-absorbing alloy having composition represented by a general formula: Mm_{0.7}Mg_{0.3}Ni_{3.1}CO_{0.1}Al_{0.2}.

The hydrogen-absorbing alloy thus obtained was analyzed by an X-ray diffraction method using Cu-Kα rays as an X-ray source, which revealed that the crystal structure of the alloy was a Ce₂Ni₇ type.

Then, the ingot was mechanically pulverized in an inert gas atmosphere, and alloy powder having a particle size in the range of 400 to 200 mesh was separated by sieving. Using a laser diffraction scattering particle-size distribution measuring apparatus, particle-size/weight percentage distribution was measured on the separated alloy powder. The average particle size of the alloy powder obtained from the distribution at the 50% integrated weight was 45 μm.

Then, by mass, 0.4 parts of polyacrylic sodium, 0.1 part of carboxymethylcellulose and 2.5 parts of a polytetrafluoroethylene dispersion liquid (dispersion medium consisting of, by mass, 40 parts of water and 60 parts of solids) were added to 100 parts of the above-mentioned alloy powder and kneaded, to thereby obtain negative-electrode active material slurry.

Onto both sides of a Fe punching metal substrate which has a 60 μm thickness and surfaces having Ni plating on both sides, the obtained slurry was applied uniformly to have a fixed thickness on both sides, and dried. Then, the punching metal substrate was pressed and cut. Thus, a negative electrode for a nickel-hydrogen secondary battery of AA size was produced.

3. Assembling of a Nickel-Hydrogen Secondary Battery

The negative and positive electrodes produced as described above were stacked in layers with a separator of polypropylene or nylon nonwoven fabric between, and the stack was placed in a battery container. Then, a 30 mass-% aqueous potassium hydroxide solution containing lithium and natrium was put in the container. Thus, a nickel-hydrogen secondary battery of AA size and nominal capacity 1200 mAh was produced.

### Examples 2 to 11

Nickel hydrogen secondary batteries of AA size and nominal capacity 1200 mAh were produced in the same way as example 1, except that in producing positive electrodes, Nb₂O₅, Yb₂O₃, Er₂O₃, Ca(OH)₂, SrO, Ba(OH)₂, TiO₂, WO₃, MoO₃ or Ta₂O₅ powder of the amount corresponding to 5 mass-% was added in place of Y₂O₃ powder, and that x in the general formula of the hydrogen-absorbing alloy was varied as shown in Table 1.

### Example 12

A nickel-hydrogen secondary battery of AA size and nominal capacity 1200 mAh was produced in the same way as example 1, except that in producing a positive electrode, composite-particle powder consisting of nickel hydroxide particles whose surfaces were coated with cobalt hydroxide was used in place of nickel hydroxide powder.

Specifically, in producing a positive electrode, after nickel hydroxide particles were precipitated in the mixed solution, an aqueous cobalt sulfate solution was added to the mixed solution for reaction. During the reaction, the pH of the mixed solution was kept at 9 to 10. As a result, cobalt hydroxide was precipitated on the surfaces of the suborbicular nickel hydroxide particles precipitated before. Then, the suborbicular nickel hydroxide particles whose surfaces were coated with cobalt hydroxide were washed three times with ten times as much pure water, then dehydrated and dried. As a result, composite-particle powder consisting of nickel hydroxide particles whose surfaces were coated with cobalt hydroxide was obtained.

### Example 13

A nickel-hydrogen secondary battery of AA size and nominal capacity 1200 mAh was produced in the same way as example 12, except that in producing a positive electrode, the crystal structure of the cobalt hydroxide which formed the coating layer was distorted and made to contain alkali cations.

Specifically, after the composite-particle powder was obtained in the same way as in example 12, sodium hydroxide of 25 mass-% concentration was sprayed over the composite-particle powder in an atmosphere heated at 100° C. for 0.5 hours. Then, the powder was washed three times with ten times as much pure water, then dehydrated and dried. As a result, composite-particle powder consisting of nickel hydroxide particles whose surfaces were coated with cobalt hydroxide having distorted crystal structure and containing alkali cations was obtained. This powder was used as a positive-electrode active material.

### Example 14

A nickel-hydrogen secondary battery of AA size and nominal capacity 1200 mAh was produced in the same way as example 13, except that in producing a positive electrode, composite particles consisting of higher-order cobalt hydroxide particles whose surfaces were coated with a higher-order cobalt compound having distorted crystal structure were used as the active material.

Specifically, after the composite-particle powder consisting of nickel hydroxide particles whose surfaces were coated with cobalt hydroxide having distorted crystal structure and containing alkali cations was obtained in the same way as in example 13, the powder was put in aqueous sodium hydroxide solution of a 32 mass-% concentration kept at 60° C. Then a predetermined amount of sodium hypochlorite was dropped into the aqueous sodium hydroxide solution while being stirred. As a result, both the cobalt hydroxide which formed the coating layer and the nickel hydroxide under the coating layer were oxidized and converted into a higher-order cobalt compound and higher-order nickel hydroxide, respectively.

Then, the particles were washed three times with ten times as much pure water, then dehydrated and dried. As a result, composite-particle powder consisting of higher-order cobalt hydroxide particles whose surfaces were coated with a higher-order cobalt compound having distorted crystal structure and containing alkali cations was obtained.

In the above process, the valency of nickel can be controlled by adjusting the amount of dropped sodium hypochlorite, appropriately. In this example, the amount of dropped sodium hypochlorite was so arranged that in 20% of nickel contained in the nickel hydroxide particles, the valency would change from 2 to 3, or in other words, that the average valency of nickel would become 2.2.

### Example 15

A nickel-hydrogen secondary battery of AA size and nominal capacity 1200 mAh was produced in the same way as example 14, except that in producing a positive electrode, the amount of dropped sodium hypochlorite was so adjusted that the average valency of nickel in the higher-order nickel hydroxide would become 2.4.

### Comparative Example 1

A nickel-hydrogen secondary battery of AA size and nominal capacity 1200 mAh was produced in the same way as example 1, except that in producing a negative electrode, an ingot of an ordinary hydrogen-absorbing alloy having composition represented by a general formula: Mm_{1.0}Ni_{4.1}Cu_{0.3}Mn_{0.4}Al_{0.2} and AB₅ type crystal structure was used.

### Comparative Example 2

A nickel-hydrogen secondary battery of AA size and nominal capacity 1200 mAh was produced in the same way as example 2, except that in producing a negative electrode, an ingot of an ordinary hydrogen-absorbing alloy having composition represented by a general formula Mm_{1.0}Ni_{4.0}C_{0.6}Mn_{0.1}Al_{0.3} and AB₅ type crystal structure was used.

### Comparative Example 3

A nickel-hydrogen secondary battery of AA size and nominal capacity 1200 mAh was produced in the same way as example 1, except that in producing a positive electrode, Y₂O₃ powder was not added.

### Comparative Examples 4 and 5

Nickel hydrogen secondary batteries of AA size and nominal capacity 1200 mAh were produced in the same way as example 1, except that in producing a positive electrode, x in the general formula of the hydrogen-absorbing alloy was varied as shown in table 1.

4. Evaluation Tests of Batteries

Evaluation tests described below were carried out on all the obtained examples and comparative examples of nickel-hydrogen secondary battery. The results are shown in table 1. In table 1, the results are shown in relative values, where the results of comparative example 3 are considered as 100.

(1) Measurement of Battery Capacity

The capacity of each battery was measured at room temperature 25° C. and at 60° C., in the manner that the battery was charged with a current at 120 mA for 16 hours and made to discharge a current at 1200 mA until it reached the final voltage of 0.5V.

(2) Continuous Charging Test

The capacity of each battery was measured in an atmosphere of 60° C. in the manner that the battery was charged with a current at 120 mA for 2 weeks and made to discharge a current at 1200 mA until it reached the final voltage of 0.5V. This process of measurement was repeated until the measured capacity became 60% or lower of the initially measured capacity. The number of repetitions was considered as a continuous-charging life.

TABLE 1

| | Electrode materials | | | | | | | |
|---|---|---|---|---|---|---|---|---|
| | Positive electrode | | | | | | | |
| | Positive- | | | | | Evaluation | | |
| | electrode | Average | | | Negative- | Capacity | | Continuous- |
| | active | valency of | | | electrode active | Room | | charging |
| | material | nickel | Additive | Coating layer | material | temperature | 60° C. | life |
| Example 1 | Nickel | 2.0 | Y₂O₃ | None | Mm_{0.7}Mg_{0.3}Ni_{3.1}Co_{0.1}Al_{0.2} | 100 | 165 | 98 |
| | hydroxide | | | | | | | |
| Example 2 | Nickel | 2.0 | Nb₂O₅ | None | Mm_{0.7}Mg_{0.3}Ni_{3.1}Co_{0.1}Al_{0.2} | 100 | 164 | 102 |
| | hydroxide | | | | | | | |
| Example 3 | Nickel | 2.0 | Yb₂O₃ | None | Mm_{0.9}Mg_{0.1}Ni_{3.1}Co_{0.1}Al_{0.2} | 100 | 164 | 101 |
| | hydroxide | | | | | | | |
| Example 4 | Nickel | 2.0 | Er₂O₃ | None | Mm_{0.8}Mg_{0.2}Ni_{3.1}Co_{0.1}Al_{0.2} | 100 | 165 | 100 |
| | hydroxide | | | | | | | |
| Example 5 | Nickel | 2.0 | Ca(OH)₂ | None | Mm_{0.6}Mg_{0.4}Ni_{3.1}Co_{0.1}Al_{0.2} | 100 | 163 | 99 |
| | hydroxide | | | | | | | |
| Example 6 | Nickel | 2.0 | SrO | None | Mm_{0.5}Mg_{0.5}Ni_{3.1}Co_{0.1}Al_{0.2} | 100 | 166 | 100 |
| | hydroxide | | | | | | | |
| Example 7 | Nickel | 2.0 | BA(OH)₂ | None | Mm_{0.4}Mg_{0.6}Ni_{3.1}Co_{0.1}Al_{0.2} | 100 | 164 | 100 |
| | hydroxide | | | | | | | |
| Example 8 | Nickel | 2.0 | TiO₂ | None | Mm_{0.3}Mg_{0.7}Ni_{3.1}Co_{0.1}Al_{0.2} | 100 | 164 | 99 |
| | hydroxide | | | | | | | |
| Example 9 | Nickel | 2.0 | WO₃ | None | Mm_{0.2}Mg_{0.8}Ni_{3.1}Co_{0.1}Al_{0.2} | 100 | 165 | 102 |
| | hydroxide | | | | | | | |
| Example | Nickel | 2.0 | MoO₃ | None | Mm_{0.1}Mg_{0.9}Ni_{3.1}Co_{0.1}Al_{0.2} | 100 | 163 | 100 |
| 10 | hydroxide | | | | | | | |
| Example | Nickel | 2.0 | Ta₂O₅ | None | Mm_{0.7}Mg_{0.3}Ni_{3.1}Co_{0.1}Al_{0.2} | 100 | 163 | 100 |
| 11 | hydroxide | | | | | | | |
| Example | Nickel | 2.0 | Y₂O₃ | Cobalt hydroxide | Mm_{0.7}Mg_{0.3}Ni_{3.1}Co_{0.1}Al_{0.2} | 102 | 168 | 99 |
| 12 | hydroxide | | | | | | | |
| Example | Nickel | 2.0 | Y₂O₃ | Cobalt hydroxide | Mm_{0.7}Mg_{0.3}Ni_{3.1}Co_{0.1}Al_{0.2} | 105 | 170 | 100 |
| 13 | hydroxide | | | containing | | | | |
| | | | | alkali cations | | | | |
| Example | Higher-order | 2.2 | Y₂O₃ | Higher-order | Mm_{0.7}Mg_{0.3}Ni_{3.1}Co_{0.1}Al_{0.2} | 107 | 172 | 101 |
| 14 | nickel | | | cobalt hydroxide | | | | |
| | hydroxide | | | containing | | | | |
| | | | | alkali cations | | | | |
| Example | Higher-order | 2.4 | Y₂O₃ | Higher-order | Mm_{0.7}Mg_{0.3}Ni_{3.1}Co_{0.1}Al_{0.2} | 107 | 172 | 101 |
| 15 | nickel | | | cobalt hydroxide | | | | |
| | hydroxide | | | containing | | | | |
| | | | | alkali cations | | | | |
| Comparative | Nickel | 2.0 | Y₂O₃ | None | Mm_{1.0}Ni_{4.1}Co_{0.3}Mn_{0.4}Al_{0.2} | 100 | 165 | 72 |
| example 1 | hydroxide | | | | | | | |
| Comparative | Nickel | 2.0 | Nb₂O₅ | None | Mm_{1.0}Ni_{4.0}Co_{0.6}Mn_{0.1}Al_{0.3} | 100 | 164 | 79 |
| example 2 | hydroxide | | | | | | | |
| Comparative | Nickel | 2.0 | None | None | Mm_{0.7}Mg_{0.3}Ni_{3.1}Co_{0.1}Al_{0.2} | 100 | 100 | 100 |
| example 3 | hydroxide | | | | | | | |
| Comparative | Nickel | 2.0 | Y₂O₃ | None | Mm_{1.0}Ni_{3.1}Co_{0.1}Al_{0.2} | 100 | 164 | 74 |
| example 4 | hydroxide | | | | | | | |
| Comparative | Nickel | 2.0 | Y₂O₃ | None | Mg_{1.0}Ni_{3.1}Co_{0.1}Al_{0.2} | 100 | 165 | 102 |
| example 5 | hydroxide | | | | | | | |

From table 1, the following are apparent:

(1) Examples 1 to 11 and comparative examples 1 and 2 of nickel-hydrogen secondary battery which use a positive electrode containing at least one element selected from a group consisting of Y, Yb, Er, Ca, Sr, Ba, Nb, Ti, W, Mo and Ta have higher capacity in a high-temperature atmosphere than comparative example 3 which does not contain any of these elements. This is because these elements make the oxygen overvoltage in a high-temperature atmosphere higher.

(2) Examples 1 to 11 of nickel-hydrogen secondary battery which use a negative electrode using hydrogen-absorbing alloy containing Mg has a longer continuous charging life than comparative examples 1 and 2 which use AB₅ type hydrogen-absorbing alloy. This is thought to be because Mg in the hydrogen-absorbing alloy restrains production of gamma nickel oxyhydroxide or restrains the alkaline electrolyte being absorbed and held in the positive electrode due to production of gamma nickel oxyhydroxide production, in continuous charging.

(3) Examples 1, 12, 13 and 14 show that addition of Y₂O₃ powder or Nb₂O₅ powder, formation of the coating layer comprising a cobalt-compound, or conversion of nickel hydroxide to higher-order nickel hydroxide can increase the battery capacity at room temperature, respectively.

As is apparent from the above, the nickel-hydrogen secondary battery according to the invention has a good charging characteristic as well as a good continuous charging characteristic in a high-temperature atmosphere. The industrial value thereof is very high.

What is claimed is:

1. A nickel-hydrogen secondary battery comprising a positive electrode and a negative electrode opposite each other with a separator between, and contained in a container with an alkaline electrolyte;
wherein the positive electrode contains nickel hydroxide, and at least one element selected from a group consisting of Y, Yb, Er, Ca, Sr, Ba, Nb, Ti, W, Mo and Ta; and
wherein the negative electrode contains a hydrogen-absorbing alloy having composition represented by a general formula
Ln₁₋ₓMgₓ(Ni₁₋ₓT_{y})_{z},
where Ln is at least one element selected from a group consisting of the lanthanoids, Ca, Sr, Sc, Y, Ti, Zr and Hf, T is at least one element selected from a group consisting of V, Nb, Ta, Cr, Mo, Mn, Fe, Co, Al, Ga, Zn, Sn, In, Cu, Si, P and B, and x, y and z are numerical values satisfying the requirements 0<x<1, 0≦y≦0.5, and 2.5≦z≦4.5, respectively.

2. The nickel-hydrogen secondary battery according to claim 1, wherein the surface of the nickel hydroxide is coated with a cobalt compound.

3. The nickel-hydrogen secondary battery according to claim 2, wherein the cobalt compound is a higher-order cobalt compound which has distorted crystal structure and contains alkali cations.

4. The nickel-hydrogen secondary battery according to claim 3, wherein the average valency of nickel contained in the nickel hydroxide is higher than 2.

5. The nickel-hydrogen secondary battery according to claim 4, wherein the average valency of nickel contained in the nickel hydroxide is in the range of 2.05 to 2.30.

6. The nickel-hydrogen secondary battery according to claim 5, wherein the average valency of nickel contained in the nickel hydroxide is in the range of 2.10 to 2.30.

7. The nickel-hydrogen secondary battery according to any of claims 1 to 6, wherein the nickel hydroxide contains Co and Zn in a form of a solid solution.

8. The nickel-hydrogen secondary battery according to claim 7, wherein the positive electrode contains at least one compound selected from a group consisting of Y₂O₃, Nb₂O₅, Yb₂O₃, Er₂O₃, Ca(OH)₂, SrO, Ba(OH)₂, TiO₂, WO₂, WO₃, MoO₂, MoO₃ and Ta₂O₅.

9. The nickel-hydrogen secondary battery according to claim 8, wherein the positive electrode contains Y₂O₃.

10. The nickel-hydrogen secondary battery according to claim 9, wherein the hydrogen-absorbing alloy contains La, Nd, Pr, Co and Al.
